(19) United States
(12) Patent Application Publication
(10) Pub. No.: US 2022/0122109 A1
(43) Pub. Date: Apr. 21, 2022

(54) METHOD OF MANAGING DIGITAL CONTENT, DEVICE, AND READABLE STORAGE MEDIUM

(71) Applicant: Beijing Baidu Netcom Science Technology Co., Ltd., Beijing (CN)

(72) Inventors: Bingjie HU, Beijing (CN); Shichen SHAO, Beijing (CN); Yongheng LI, Beijing (CN); Mengze LI, Beijing (CN)

(21) Appl. No.: 17/646,113

(22) Filed: Dec. 27, 2021

(30) Foreign Application Priority Data
Mar. 11, 2021 (CN) 202110267716.8

(51) Int. Cl. G06Q 30/02

(52) U.S. Cl. CPC G06Q 30/0211

(57) ABSTRACT

A method of managing a digital content, a device, and a readable storage medium, relate to a field of data processing, and in particular to intelligent search and big data. The method includes: determining a set of attributes of a use voucher for a target digital content based on a content feature of the target digital content and a user feature of a user associated with the target digital content; determining an initial value of an indication parameter associated with a use of the use voucher based on the attribute values of the set of attributes; transmitting the initial value to acquire an indication of whether to use the use voucher or not; adjusting the attribute values of the set of attributes so as to determine a target value of the indication parameter, in response to receiving an indication of using the use voucher.

### CROSS REFERENCE TO RELATED APPLICATION(S)

The application claims priority to Chinese Patent Application No. 202110267716.8, filed on Mar. 11, 2021, the entire contents of which are incorporated herein in their entireties by reference.

### TECHNICAL FIELD

The present disclosure relates to the field of data processing technology, and in particular to a method of managing a digital content, a device, and a readable storage medium in the field of intelligent search and big data.

### BACKGROUND

With the rapid development of computer technology, many knowledge contents are not presented by a conventional physical carrier, but as digital contents on a network. Thus, a user of a digital content may acquire various digital contents via the network. Moreover, with more and more producers of digital contents, more and more types and forms of digital contents, such as various documents, audio and video files and so on, are presented on the network. As an amount of digital contents increases, a producer of the digital contents needs to manage the digital contents. However, many problems to be solved exist in a process of managing the digital contents.

### SUMMARY

The present disclosure provides a method of managing a digital content, a device, and a readable storage medium.

According to a first aspect of the present disclosure, a method of managing a digital content is provided, including: determining a set of attributes of a use voucher for a target digital content based on a content feature of the target digital content and a user feature of a user associated with the target digital content, wherein the set of attributes contain attribute values; determining an initial value of an indication parameter associated with a use of the use voucher based on the attribute values of the set of attributes; transmitting the initial value of the indication parameter so as to acquire an indication of whether to use the use voucher or not; and adjusting the attribute values of the set of attributes so as to determine a target value of the indication parameter, in response to receiving an indication of using the use voucher.

According to a second aspect of the present disclosure, an electronic device is provided, including: at least one processor; and a memory communicatively connected to the at least one processor, wherein the memory stores instructions executable by the at least one processor, and the instructions, when executed by the at least one processor, cause the at least one processor to implement the method according to the first aspect of the present disclosure.

According to a third aspect of the present disclosure, a non-transitory computer-readable storage medium having computer instructions therein is provided, the computer instructions, when executed by a computer, configured to cause the computer to implement the method according to the first aspect of the present disclosure.

It should be understood that content described in this section is not intended to identify key or important features in the embodiments of the present disclosure, nor is it intended to limit the scope of the present disclosure. Other features of the present disclosure will be easily understood through the following description.

### BRIEF DESCRIPTION OF THE DRAWINGS

FIG. 1 shows a schematic diagram of an environment 100 in which various embodiments of the present disclosure may be implemented.

FIG. 2 shows a flowchart of a method 200 of managing a digital content according to some embodiments of the present disclosure.

FIG. 3 shows a schematic diagram of an exemplary process 300 of managing a digital content according to some embodiments of the present disclosure.

FIG. 4 shows a block diagram of an apparatus 400 of managing a digital content according to some embodiments of the present disclosure.

FIG. 5 shows a block diagram of a device 500 for implementing various embodiments of the present disclosure.

### DETAILED DESCRIPTION OF EMBODIMENTS

The following describes exemplary embodiments of the present disclosure with reference to the accompanying drawings, which include various details of the embodiments of the present disclosure to facilitate understanding, and should be considered as merely exemplary. Therefore, those of ordinary skilled in the art should realize that various changes and modifications may be made to the embodiments described herein without departing from the scope and spirit of the present disclosure. Likewise, for clarity and conciseness, descriptions of well-known functions and structures are omitted in the following description.

In the description of the embodiments of the present disclosure, the term “including” and similar terms should be understood as open-ended inclusion, that is, “including but not limited to”. The term “based on” should be understood as “at least partially based on.” The term “an embodiment,” “one embodiment” or “this embodiment” should be understood as “at least one embodiment.” The terms “first,” “second,” and the like may refer to different objects or the same object. The following may also include other explicit and implicit definitions.

An amount of the digital content such as knowledge content on the network is increasing rapidly. A producer of a digital content may issue a use voucher for each content to a user. The use voucher may be, for example, a coupon provided by the producer of the digital content. Then, after obtaining the use voucher, the user may determine whether to further obtain the digital content, such as purchasing the digital content, by using the use voucher.

However, the large number of producers of digital content may have different management capabilities for digital content. In a conventional solution, the method of issuing the use voucher may be manual configuration. The producer may manually set, in a background, a value for a worth of the use voucher, a use time of the use voucher, and an issuance range of the user voucher according to his/her own understanding for the user to receive and use. However, the manual configuration is inefficient, and some producers may have no time and energy to configure. In addition, there is a lack of a measurement model for a use effect of the use voucher, so that an effect of configuring the use voucher may not be measured. In addition, it is difficult for the producer to dynamically adjust the value for the worth of the use voucher according to an issuance effect of the use voucher so as to maximize benefit of the producer of the digital content.

In order to at least solve the above-mentioned problem, an improved solution of managing a digital content is proposed according to some embodiments of the present disclosure. In this solution, a computing device may determine a set of attributes of a use voucher for a target digital content based on a content feature of the target digital content and a user feature of a user associated with the target digital content. The set of attributes may contain attribute values. Then, the computing device may determine an initial value of an indication parameter associated with a use of the use voucher by using the attribute values of the set of attributes. The initial value of the indication parameter may be transmitted to a user to acquire an indication of whether to use the use voucher or not. In response to receiving an indication of using the use voucher, the attribute values of the set of attributes may be adjusted to determine a target value of the indication parameter. Through this method, the use voucher may be automatically configured for the producer of the digital content quickly and efficiently, which may save time for the producer, improve efficiency, and improve user experience.

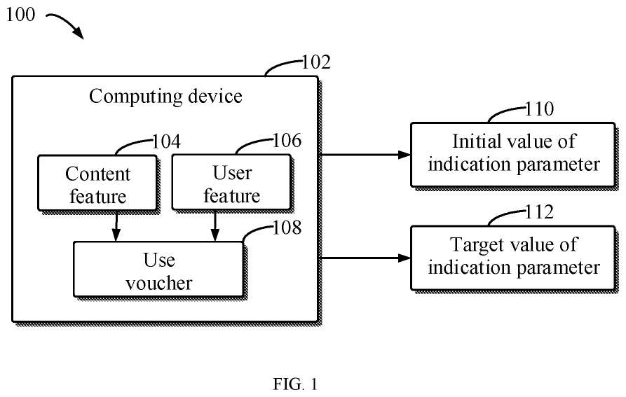

FIG. 1 shows a schematic diagram of an environment 100 in which various embodiments of the present disclosure may be implemented. The exemplary environment 100 may include a computing device 102.

The computing device 102 may manage a use of a use voucher 108 based on a content feature 104 of a digital content and a user feature 106 of a user. The exemplary computing device 102 includes, but is not limited to a personal computer, a server computer, a handheld or laptop device, a mobile device (such as a mobile phone, a personal digital assistant (PDA), a media player), a multiprocessor system, a consumer electronic product, a small computer, a large computer, a distributed computing environment including any one of the above systems or devices, and so on. The server may be a cloud server, also known as a cloud computing server or a cloud host, which is a host product in a cloud computing service system to solve defects of difficult management and weak business scalability existing in a conventional physical host and a VPS (Virtual Private Server) service. The server may also be a server of a distributed system or a server combined with a block-chain.

The content feature 104 of the digital content may be a title of the digital content, a content category of the digital content, and/or a content point of the digital content. The digital content may be data such as a document, a video, or an audio. The digital content may be produced by different producers. For example, the document may be edited by a document creator, and the video may be made by a video photographer. In addition, a knowledge graph for the digital content may be generated by using the title of the digital content, the content category of the digital content, and the content point of the digital content. The knowledge graph may contain an association relationship between the document and the content category as well as the content point.

In some embodiments, in the knowledge graph, the content point may be contained in the content category. For example, when the digital content is a knowledge content, the content category may include three levels. A first level of category may include categories of education, literature, art, and so on. The first level of category may include a second level of category. For example, the category of education may include categories of high school, junior middle school, primary school, and so on. The second level of category may include a third level of category. For example, the category of junior middle school may be divided into categories of Chinese, Mathematics, Geography, and so on. The content point may be a specific knowledge point contained in a category of the third level of category. For example, the content point may be an introduction for a grammar contained in the category of Chinese. In some embodiments, a document title may be associated with the content category and the content point based on a document content. The above examples are only for describing the present disclosure and are not specific limitations to the present disclosure. The digital content may be divided into any appropriate category and any number of levels of categories, and may form a knowledge graph in any appropriate way.

The computing device 102 may obtain a reference digital content similar to a target digital content based on the content feature 104 of the target digital content. In some embodiments, a digital content involving the content point associated with the target digital content may be determined as the reference digital content according to the knowledge graph. In some embodiments, a digital content whose title matching degree with the target digital content exceeds a matching degree threshold may be used as the reference digital content. In some embodiments, a digital content whose title matching degree with the target digital content exceeds the matching degree threshold and whose content category matching degree with the target digital content exceeds another matching degree threshold may be used as the reference digital content. The above examples are only for describing the present disclosure and are not specific limitations to the present disclosure.

In some embodiments, the computing device 102 may determine a historical level of a worth of the reference digital content as a level of a worth of the target digital content. In an example, if a plurality of reference digital contents are determined, the level of the worth of the target digital content may be determined by calculating an average of the historical values for the worth of the reference digital contents. In another example, if a plurality of reference digital contents are determined, the level of the worth of the target digital content may be determined by calculating a weighted average of the historical values for the worth of the reference digital contents. In yet another example, if a plurality of reference digital contents are determined, the level of the worth of the target digital content may be determined by randomly selecting a historical value for a worth of one of the plurality of reference digital contents. The above examples are only for describing the present disclosure and are not specific limitations to the present disclosure.

Then, the computing device 102 further needs to determine an initial range of target user from users who have used the digital content. The computing device 102 may find all users who have used the digital content and determine a user feature 106 of these users. Then, the initial range of target user to whom the use voucher may be issued may be determined from all the users by using the user feature.

In some embodiments, the user feature 106 may be a historical consumption level of the user. The producer of the target digital content may set a predetermined level of the worth of the target digital content. The computing device 102 may determine a user whose historical consumption level is lower than the predetermined level and assign the user into the initial range of target user. Then, the use voucher may be issued to the user so as to promote the user to obtain the digital content. In another example, the user feature 106 may be a gender or an age of the user. Then, a user with a predetermined gender or within a predetermined age range may be selected as the target user. The above examples are only for describing the present disclosure and are not specific limitations to the present disclosure.

The computing device 102 may determine a set of attribute values of a set of attributes of the use voucher for the target digital content by using the content feature 104 and the user feature 106. For example, an initial level of the worth of the use voucher, the initial range of target user, an initial requirement of a use condition, and an initial value of a validity period may be determined. A use time of the use voucher may be determined by the producer.

After the set of attribute values of the set of attributes of the use voucher is determined, an initial value of an indication parameter associated with a use of the use voucher may be determined. In an example, the indication parameter may be Cost Per Mille. In some embodiments, the indication parameter may be a benefit value for the digital content after the use voucher is used. The above examples are only for describing the present disclosure and are not specific limitations to the present disclosure.

The computing device 102 may return an initial value 110 of the indication parameter to the user. The user may then determine whether to issue the use voucher to the target user or not. If the user determines not to issue the user voucher to the user, the use voucher may not be issued to the user. If the user determines that the use voucher can be issued to the user, the attribute values of the set of attributes may be continuously adjusted during an issuance process, and a target value 112 of the indication parameter, for example, a maximum value of the indication parameter, may be obtained by a result of comparing different attribute values. The above examples are only for describing the present disclosure and are not specific limitations to the present disclosure.

Through this method, the use voucher may be automatically configured for the producer of the digital content quickly and efficiently, which may save time for the producer, improve efficiency, and improve the user experience.

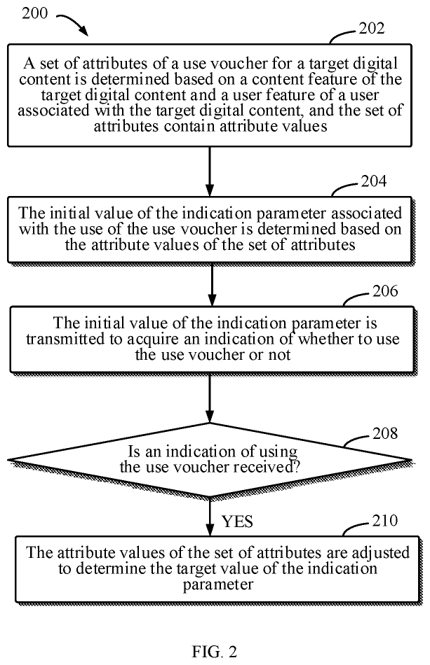

The environment 100 in which a plurality of embodiments of the present disclosure may be implemented is described above with reference to FIG. 1. A flowchart of a method 200 of managing a digital content according to some embodiments of the present disclosure will be described below with reference to FIG. 2. The method 200 in FIG. 2 may be performed by the computing device 102 in FIG. 1 or any appropriate computing device.

In block 202, a set of attributes of a use voucher for a target digital content is determined based on a content feature of the target digital content and a user feature of a user associated with the target digital content, and the set of attributes contain attribute values. For example, the computing device 102 in FIG. 1 may determine the set of attributes of the use voucher for the target digital content and the set of attribute values for the set of attributes by using the content feature 104 and the user feature 106. In some embodiments, the set of attributes includes a worth of the use voucher, an initial range of a target user group, a use condition, a validity period, and so on. The set of attribute values includes an initial value for the worth of the use voucher, an initial value of the target user group, an initial requirement of the use condition, an initial value of the validity period, and so on. The initial value of the validity period may be set to any appropriate time period by the producer of the target digital content.

In some embodiments, the set of attributes includes at least the worth of the use voucher. The computing device 102 may determine the content feature of the target digital content. The content feature 104 of the digital content may be the title of the digital content, the content category of the digital content, and/or the content point of the digital content. Then, a reference digital content associated with the target digital content may be determined from a knowledge graph associated with the target digital content, by using the content feature of the target digital content. Next, the computing device 102 may acquire a first reference value for a worth of the reference digital content. The first reference value may be used to determine a second reference value for a worth of the target digital content. For example, a historical value for the worth of the reference digital content may be determined as a current value for the worth of the target digital content. The above examples are only for describing the present disclosure and are not specific limitations to the present disclosure.

The computing device 102 may determine a first value for the worth of the use voucher by using the second reference value for the worth of the target digital content. In this way, the value for the worth of the use voucher may be determined quickly and accurately.

In some embodiments, the computing device 102 may acquire a preset value for the worth of the target digital content. For example, the computing device 102 may receive from the user the preset value for the worth of the target digital content set by the user. Then, the computing device 102 may determine the first value for the worth of the use voucher by using the second reference value for the worth of the target digital content and the preset value for the worth of the target digital content. The first value may be used as the initial value for the worth of the use voucher. For example, the first value for the worth of the use voucher may be determined by subtracting the second reference value from the preset value. In this way, the initial value for the worth of the use voucher may be determined quickly and accurately.

In some embodiments, the initial requirement of the use condition may be determined based on the preset value for the worth of the target digital content set by the producer and the first value for the worth of the use voucher. For example, when the initial requirement is to meet the preset value, the target digital content may be acquired by using the use voucher with the first value.

In some embodiments, the computing device 102 may determine, based on the preset value for the worth of the target digital content and the user feature, the initial range of the target user group allowed to use the use voucher from users associated with the target digital content. In this way, the user group allowed to use the use voucher may be determined accurately.

In block 204, the initial value of the indication parameter associated with the use of the use voucher is determined based on the attribute values of the set of attributes. After obtaining the attribute values of the set of attributes, the computing device may determine the initial value of the indication parameter by using the attribute values. In some embodiments, the indication parameter may be Cost Per Mille. In this way, the benefit of the user may be determined accurately.

In some embodiments, the initial value of the indication parameter may be determined using an effect measurement model for intelligently issuing the use voucher. Firstly, the effect measurement model is built. A core objective of the effect measurement model is to maximize Cost Per Mille (CPM) of traffic, where CPM=user purchase cost/page-views*1000. The user purchase cost of the digital content: F(e)=f (c, q, n, p) mainly depends on following factors.

A first factor is a worth c of the use voucher, which needs to be determined by considering both an intention of the producer and an intention of the user. If the value for the worth of the use voucher is too high, the producer's benefit may be reduced. If the value for the worth of the use voucher is too low, the user's motivation to obtain the digital content may decrease. There is a parabolic relationship between the value for the worth of the use voucher and the use effect of the use voucher. Therefore, an optimal point to meet a supply-demand relationship needs to be determined.

A second factor is a use condition q for the use voucher. If the use condition is too strict, it may bring more benefits to the producer, or directly lead to a user churn and thus cause a loss to the producer. Therefore, the use voucher needs to be determined according to a relevance of a document of the producer. The more relevant the document is, the more likely the user is to use the use condition. Therefore, an optimal use condition for the use voucher for the document of the producer needs to be determined.

A third factor is a validity period n of the use voucher. If the validity period of the use voucher is too long, the user lacks a sense of urgency, but a long duration of a discount may lead to a wide range of promotion. If the validity period of the use voucher is too short, the user may have a strong sense of urgency and the benefit may be improved, but a short duration may lead to a small range of promotion. There is a parabolic relationship between the use time of the use voucher and the use effect of the use voucher. Therefore, an optimal use time needs to be determined.

A fourth factor is a target user group p for the use voucher, which needs to be determined by considering user's psychological expectation. If the user initiatively acquires the digital content, issuing the use voucher may reduce the benefit of the producer. If the user is in a hesitation period, issuing the use voucher may promote an acquisition of the digital content, and the benefit of the producer may be improved. Therefore, an appropriate target user group for issuance needs to be determined.

In some embodiments, the computing device 102 may test in advance by using a portion of traffic the attribute values of the user voucher described above and obtain the user purchase cost. Then, the initial value of the indication parameter may be obtained according to the user purchase cost.

In some embodiments, a functional relationship between the indication parameter and the set of attributes may be constructed by using historical data. For example, a fitting may be performed to obtain the functional relationship between the indication parameter and the set of attributes by using the historical data. The initial value of the set of attributes may be entered into the function to obtain the initial value of the indication parameter. The above examples are only for describing the present disclosure and are not specific limitations to the present disclosure.

In block 206, the initial value of the indication parameter is transmitted to acquire an indication of whether to use the use voucher or not. For example, the computing device 102 may return the initial value of the indication parameter to the user to determine whether to issue the use voucher to the user. Alternatively or additionally, the use voucher and the attribute values are transmitted to the user.

In block 208, it is determined whether an indication of using the use voucher is received from the user. If no indication is received, no further processing is performed. If the indication is received, then in block 210, the attribute values of the set of attributes are adjusted to determine the target value of the indication parameter. The computing device 102 may determine the target value of the indication parameter by adjusting the attribute values of the set of attributes. For example, an optimal value of the indication parameter may be obtained. In this case, the set of attribute values is an optimal value of the set of attributes.

In some embodiments, the computing device 102 may adjust the attribute values of the set of attributes so as to acquire a set of adjusted attribute values, in response to receiving the indication of using the use voucher. The computing device 102 may compare the initial value of the indication parameter with an adjusted value of the indication parameter obtained from the adjusted attribute values, so as to determine the target value of the indication parameter. In this way, the optimal value of the indication parameter may be determined quickly.

For example, the attribute values may be changed using an A/B test method. The A/B test method is to change a attribute value of only one attribute while keeping the attribute values of other attributes unchanged, and then compare the values of the indication parameter obtained from the two different attribute values, so that the attribute value that maximizes the value of the indication parameter may be selected from the two attribute values of the adjusted attribute. The value of each attribute may be adjusted by this method. Then, the computing device 102 may determine an adjusted value of the indication parameter. Each attribute may be continuously adjusted in this way so as to finally obtain the target value of the indication parameter, which is the optimal value of the indication parameter.

In this way, the use voucher may be automatically configured for the producer of the digital content quickly and efficiently, which may save time for the producer, improve the efficiency, and improve the user experience.

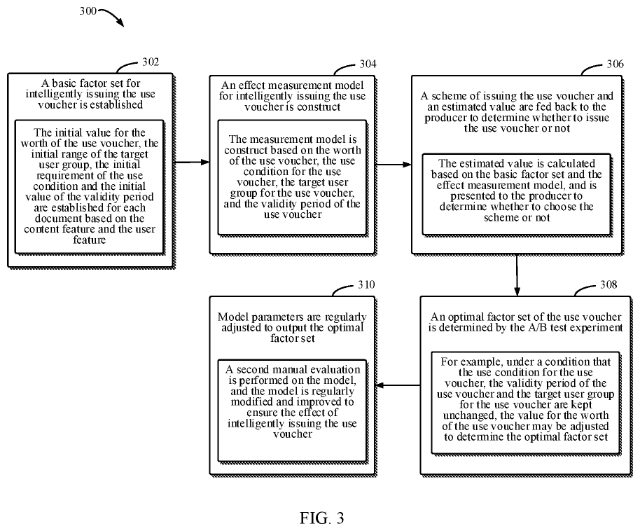

The flowchart of the method 200 of managing the digital content according to some embodiments of the present disclosure is described above with reference to FIG. 2. A flowchart of an exemplary process 300 of managing a digital content according to some embodiments of the present disclosure will be described below with reference to FIG. 3. The process 300 in FIG. 3 may be performed by the computing device 102 in FIG. 1 or any appropriate computing device.

In block 302, the computing device 102 establishes a basic factor set for intelligently issuing the use voucher, that is, determines a set of attribute values of a set of attributes of the use voucher. Specifically, a basic factor set including the initial value for the worth of the use voucher, the initial range of the target user group, the initial requirement of the use condition, the initial value of the validity period, and so on is established for each digital content based on the content feature and the user feature.

In some embodiments, a complete knowledge graph may be constructed based on the title of the digital content, the content point of the digital content, and the content category of the digital content, so as to acquire a related digital content. Then, the historical value for the worth of the related digital content may be acquired, the reference value for the worth of the digital content may be inferred according to the historical value for the worth of the related digital content, and a difference between the reference value and the preset value is determined as the initial value for the worth of the use voucher. In an example, the historical value for the worth of the related digital content is a historical price of the related digital content. The above examples are only for describing the present disclosure and are not specific limitations to the present disclosure.

Then, the computing device 102 may determine, according to the preset value for the worth of the digital content set by the producer and the historical consumption level of the user, a user group whose consumption level is lower than the preset value for the worth of the digital content as the initial range of the target user group for the use voucher.

According to the above steps, the initial value for the worth of the use voucher and the initial range of the target user group are determined for each digital content, the preset value for the worth of the digital content is used as the initial requirement of the use condition for the use voucher, and a predetermined duration, such as one day, is determined as the initial value of the validity period, so as to establish the basic factor set of the use voucher.

In block 304, the computing device 102 constructs an effect measurement model for intelligently issuing the use voucher. The computing device 102 may construct the measurement model based on the worth of the use voucher, the use condition for the use voucher, the target user group for the use voucher, and the validity period of the use voucher.

A core objective of the effect measurement model is to maximize Cost Per Mille (CPM) of traffic, where CPM=user purchase cost/page-views*1000. In the measurement model, the worth of the use voucher, the use condition for the use voucher, the target user group for the use voucher, and the validity period of the use voucher may be used as parameters.

This model may be used to calculate the issuance effect of the use voucher. When the user browses the digital content, the issuance of the use voucher may promote a conversion, with an objective of maximizing the Cost Per Mille of the document.

In block 306, the computing device 102 feeds back a scheme of issuing the use voucher and an estimated value to the producer to determine whether to issue the use voucher or not. The estimated value is calculated based on the basic factor set and the effect measurement model described above, and is presented to the producer to determine whether to choose the scheme or not.

In block 308, the computing device 102 determines an optimal factor set of the use voucher by the A/B test experiment. The A/B test experiment is to change a value of only one factor in the factor set, and compare the results before and after the change.

For the use voucher that the producer agrees to issue, the A/B test method may be used to verify an impact of the adjustment of different factors on the effect of intelligently issuing the use voucher, so as to determine an optimal combination solution for the use voucher according to user's purchase behavior due to the change of different factors in the use voucher. For example, under a condition that the use condition for the use voucher, the validity period of the use voucher and the target user group for the use voucher are kept unchanged, the value for the worth of the use voucher may be adjusted to determine a combination solution for the use voucher corresponding to a highest flow of the digital content on a current day.

In block 310, the computing device 102 regularly adjusts model parameters to output the optimal factor set. A second manual evaluation may be performed on the model described above, and the model may be regularly modified and improved to ensure that the use voucher may be intelligently issued for content sales.

Through this method, the use voucher may be automatically configured for the producer of the digital content quickly and efficiently, which may save time for the producer, improve the efficiency, and improve the user experience.

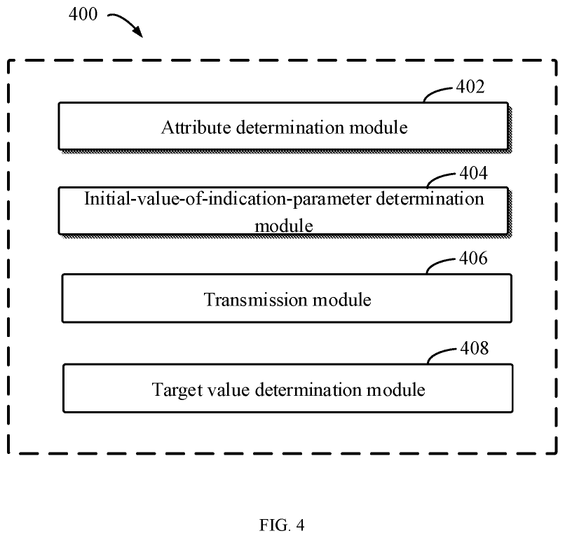

FIG. 4 shows a schematic block diagram of an apparatus 400 of managing a digital content according to some embodiments of the present disclosure. As shown in FIG. 4, the apparatus 400 includes an attribute determination module 402 used to determine a set of attributes of a use voucher for a target digital content based on a content feature of the target digital content and a user feature of a user associated with the target digital content. The set of attributes contain corresponding attribute values. The apparatus 400 may further include an initial-value-of-indication-parameter determination module 404 used to determine an initial value of an indication parameter associated with a use of the use voucher based on the attribute values of the set of attributes. The apparatus 400 may further include a transmission module 406 used to transmit the initial value of the indication parameter so as to acquire an indication of whether to use the use voucher or not. The apparatus 400 may further include a target value determination module 408 used to adjust the attribute values of the set of attributes so as to determine a target value of the indication parameter, in response to receiving an indication of using the use voucher.

In some embodiments, the set of attributes may include a worth of the use voucher, and the attribute determination module 402 may include: a content feature determination module used to determine the content feature of the target digital content; a reference digital content determination module used to determine, from a knowledge graph associated with the target digital content, a reference digital content associated with the target digital content, based on the content feature of the target digital content; a second reference value determination module used to determine a second reference value for a worth of the target digital content based on a first reference value for a worth of the reference digital content; and a first use voucher worth determination module used to determine a first value for the worth of the use voucher based on the second reference value for the worth of the target digital content.

In some embodiments, the first use voucher worth determination module may include: a preset value acquisition module used to acquire a preset value for the worth of the target digital content; and a second use voucher worth determination module used to determine the first value for the worth of the use voucher based on the second reference value for the worth of the target digital content and the preset value for the worth of the target digital content.

In some embodiments, the apparatus 400 may further include a user determination module used to determine a set of users allowed to use the use voucher from users associated with the target digital content, based on the preset value for the worth of the target digital content and the user feature.

In some embodiments, the target value determination module may include: an adjustment module used to adjust the attribute values of the set of attributes so as to acquire a set of adjusted attribute values, in response to receiving the indication of using the use voucher; an adjusted value determination module used to determine an adjusted value of the indication parameter based on the set of adjusted attribute values; and a comparison module used to compare the initial value of the indication parameter and the adjusted value of the indication parameter so as to determine the target value of the indication parameter.

In some embodiments, the indication parameter may be Cost Per Mille.

It should be noted that the historical consumption level of the user in the present disclosure is not the historical consumption level for a specific user, and cannot reflect the personal information of a specific user.

It should be noted that the acquisition, collection, storage, use, processing, transmission, provision and disclosure of the user's personal information involved in the technical scheme of the present disclosure comply with the provisions of relevant laws and regulations and do not violate public order and good customs.

According to the embodiments of the present disclosure, the present disclosure further provides an electronic device, a readable storage medium, and a computer program product.

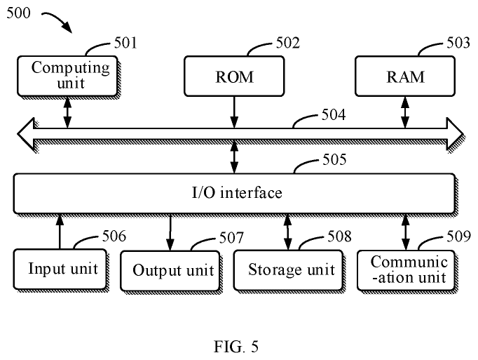

FIG. 5 shows a schematic block diagram of an exemplary electronic device 500 for implementing the embodiments of the present disclosure. The exemplary electronic device 500 is intended to implement the computing device 102 in FIG. 1. The electronic device is designed to represent various forms of digital computers, such as a laptop computer, a desktop computer, a workstation, a personal digital assistant, a server, a blade server, a mainframe computer, and other suitable computers. The electronic device may further represent various forms of mobile apparatuses, such as a personal digital assistant, a cellular phone, a smart phone, a wearable device, and other similar computing apparatuses. The components as illustrated herein, and connections, relationships, and functions thereof are merely examples, and are not intended to limit the implementation of the present disclosure described and/or required herein.

As shown in FIG. 5, the electronic device 500 includes a computing unit 501, which may perform various appropriate actions and processing based on a computer program stored in a read-only memory (ROM) 502 or a computer program loaded from a storage unit 508 into a random access memory (RAM) 503. Various programs and data required for the operation of the electronic device 500 may be stored in the RAM 503. The computing unit 501, the ROM 502 and the RAM 503 are connected to each other through a bus 504. An input/output (I/O) interface 505 is further connected to the bus 504.

Various components in the electronic device 500, including an input unit 506 such as a keyboard, a mouse, etc., an output unit 507 such as various types of displays, speakers, etc., a storage unit 508 such as a magnetic disk, an optical disk, etc., and a communication unit 509 such as a network card, a modem, a wireless communication transceiver, etc., are connected to the I/O interface 505. The communication unit 509 allows the electronic device 500 to exchange information/data with other devices through a computer network such as the Internet and/or various telecommunication networks.

The computing unit 501 may be various general-purpose and/or special-purpose processing components with processing and computing capabilities. Some examples of the computing unit 501 include but are not limited to a central processing unit (CPU), a graphics processing unit (GPU), various dedicated artificial intelligence (AI) computing chips, various computing units running machine learning model algorithms, a digital signal processor (DSP), and any appropriate processor, controller, microcontroller, and so on. The computing unit 501 may perform the various methods and processes described above, such as the method 200 and the process 300. For example, in some embodiments, the method 200 and the process 300 may be implemented as a computer software program that is tangibly contained on a machine-readable medium, such as the storage unit 508. In some embodiments, part or all of a computer program may be loaded and/or installed on the electronic device 500 via the ROM 502 and/or the communication unit 509. When the computer program is loaded into the RAM 503 and executed by the computing unit 501, one or more steps of the method 200 and the process 300 described above may be performed. Alternatively, in other embodiments, the computing unit 501 may be configured to perform the method 200 and the process 300 in any other appropriate way (for example, by means of firmware).

Various embodiments of the systems and technologies described herein may be implemented in a digital electronic circuit system, an integrated circuit system, a field programmable gate array (FPGA), an application specific integrated circuit (ASIC), an application specific standard product (ASSP), a system on chip (SOC), a complex programmable logic device (CPLD), a computer hardware, firmware, software, and/or combinations thereof. These various embodiments may be implemented by one or more computer programs executable and/or interpretable on a programmable system including at least one programmable processor. The programmable processor may be a dedicated or general-purpose programmable processor, which may receive data and instructions from the storage system, the at least one input apparatus and the at least one output apparatus, and may transmit the data and instructions to the storage system, the at least one input apparatus, and the at least one output apparatus.

Program codes for implementing the method of the present disclosure may be written in any combination of one or more programming languages. These program codes may be provided to a processor or a controller of a general-purpose computer, a special-purpose computer, or other programmable data processing devices, so that when the program codes are executed by the processor or the controller, the functions/operations specified in the flowchart and/or block diagram may be implemented. The program codes may be executed completely on the machine, partly on the machine, partly on the machine and partly on the remote machine as an independent software package, or completely on the remote machine or server.

In the context of the present disclosure, the machine readable medium may be a tangible medium that may contain or store programs for use by or in combination with an instruction execution system, device or apparatus. The machine readable medium may be a machine-readable signal medium or a machine readable storage medium. The machine readable medium may include, but not be limited to, electronic, magnetic, optical, electromagnetic, infrared or semiconductor systems, devices or apparatuses, or any suitable combination of the above. More specific examples of the machine readable storage medium may include electrical connections based on one or more wires, portable computer disks, hard disks, random access memory (RAM), read-only memory (ROM), erasable programmable read-only memory (EPROM or flash memory), optical fiber, convenient compact disk read-only memory (CD-ROM), optical storage device, magnetic storage device, or any suitable combination of the above.

In order to provide interaction with the user, the systems and technologies described here may be implemented on a computer including a display device (for example, a CRT (cathode ray tube) or LCD (liquid crystal display) monitor) for displaying information to the user, and a keyboard and a pointing apparatus (for example, a mouse or a trackball) through which the user may provide the input to the computer. Other types of apparatuses may also be used to provide interaction with users. For example, a feedback provided to the user may be any form of sensory feedback (for example, visual feedback, auditory feedback, or tactile feedback), and the input from the user may be received in any form (including acoustic input, voice input or tactile input).

The systems and technologies described herein may be implemented in a computing system including back-end components (for example, a data server), or a computing system including middleware components (for example, an application server), or a computing system including front-end components (for example, a user computer having a graphical user interface or web browser through which the user may interact with the implementation of the system and technology described herein), or a computing system including any combination of such back-end components, middleware components or front-end components. The components of the system may be connected to each other by digital data communication (for example, a communication network) in any form or through any medium. Examples of the communication network include a local area network (LAN), a wide area network (WAN), and the Internet.

The computer system may include a client and a server. The client and the server are generally far away from each other and usually interact through a communication network. The relationship between the client and the server is generated through computer programs running on the corresponding computers and having a client-server relationship with each other.

It should be understood that steps of the processes illustrated above may be reordered, added or deleted in various manners. For example, the steps described in the present disclosure may be performed in parallel, sequentially, or in a different order, as long as a desired result of the technical solution of the present disclosure may be achieved. This is not limited in the present disclosure.

The above-mentioned specific embodiments do not constitute a limitation on the scope of protection of the present disclosure. Those skilled in the art should understand that various modifications, combinations, sub-combinations and substitutions may be made according to design requirements and other factors. Any modifications, equivalent replacements and improvements made within the spirit and principles of the present disclosure shall be contained in the scope of protection of the present disclosure.

What is claimed is:

1. A method of managing a digital content, comprising:
determining a set of attributes of a use voucher for a target digital content based on a content feature of the target digital content and a user feature of a user associated with the target digital content, wherein the set of attributes contain attribute values;
determining an initial value of an indication parameter associated with a use of the use voucher based on the attribute values of the set of attributes;
transmitting the initial value of the indication parameter so as to acquire an indication of whether to use the use voucher or not; and
adjusting the attribute values of the set of attributes so as to determine a target value of the indication parameter, in response to receiving an indication of using the use voucher.

2. The method of claim 1, wherein the set of attributes contain a worth of the use voucher, and wherein the determining a set of attributes comprises:
determining the content feature of the target digital content;
determining, from a knowledge graph associated with the target digital content, a reference digital content associated with the target digital content, based on the content feature of the target digital content;
determining a second reference value for a worth of the target digital content based on a first reference value for a worth of the reference digital content; and
determining a first value for the worth of the use voucher based on the second reference value for the worth of the target digital content.

3. The method of claim 2, wherein the determining a first value for the worth of the use voucher comprises:
acquiring a preset value for the worth of the target digital content; and
determining the first value for the worth of the use voucher based on the second reference value for the worth of the target digital content and the preset value for the worth of the target digital content.

4. The method of claim 3, further comprising:
determining a set of users allowed to use the use voucher from users associated with the target digital content, based on the preset value for the worth of the target digital content and the user feature.

5. The method of claim 1, wherein the determining a target value of the indication parameter comprises:
adjusting the attribute values of the set of attributes so as to acquire a set of adjusted attribute values, in response to receiving the indication of using the use voucher;
determining an adjusted value of the indication parameter based on the set of adjusted attribute values; and
comparing the initial value of the indication parameter and the adjusted value of the indication parameter so as to determine the target value of the indication parameter.

6. The method of claim 1, wherein the indication parameter is Cost Per Mille.

7. An electronic device, comprising:
at least one processor; and
a memory communicatively connected to the at least one processor, wherein the memory stores instructions executable by the at least one processor, and the instructions, when executed by the at least one processor, cause the at least one processor to:
determine a set of attributes of a use voucher for a target digital content based on a content feature of the target digital content and a user feature of a user associated with the target digital content, wherein the set of attributes contain attribute values;
determine an initial value of an indication parameter associated with a use of the use voucher based on the attribute values of the set of attributes;
transmit the initial value of the indication parameter so as to acquire an indication of whether to use the use voucher or not; and
adjust the attribute values of the set of attributes so as to determine a target value of the indication parameter, in response to receiving an indication of using the use voucher.

8. The electronic device of claim 7, wherein the at least one processor is further configured to:
determine the content feature of the target digital content;
determine, from a knowledge graph associated with the target digital content, a reference digital content associated with the target digital content, based on the content feature of the target digital content;
determine a second reference value for a worth of the target digital content based on a first reference value for a worth of the reference digital content; and
determine a first value for the worth of the use voucher based on the second reference value for the worth of the target digital content.

9. The electronic device of claim 8, wherein the at least one processor is further configured to:
acquire a preset value for the worth of the target digital content; and
determine the first value for the worth of the use voucher based on the second reference value for the worth of the target digital content and the preset value for the worth of the target digital content.

10. The electronic device of claim 9, wherein the at least one processor is further configured to:
determine a set of users allowed to use the use voucher from users associated with the target digital content, based on the preset value for the worth of the target digital content and the user feature.

11. The electronic device of claim 7, wherein the at least one processor is further configured to:
adjust the attribute values of the set of attributes so as to acquire a set of adjusted attribute values, in response to receiving the indication of using the use voucher;
determine an adjusted value of the indication parameter based on the set of adjusted attribute values; and
compare the initial value of the indication parameter and the adjusted value of the indication parameter so as to determine the target value of the indication parameter.

12. The electronic device of claim 7, wherein the indication parameter is Cost Per Mille.

13. A non-transitory computer-readable storage medium having computer instructions therein, the computer instructions, when executed by a computer, configured to cause the computer to:
determine a set of attributes of a use voucher for a target digital content based on a content feature of the target digital content and a user feature of a user associated with the target digital content, wherein the set of attributes contain attribute values;
determine an initial value of an indication parameter associated with a use of the use voucher based on the attribute values of the set of attributes;
transmit the initial value of the indication parameter so as to acquire an indication of whether to use the use voucher or not; and
adjust the attribute values of the set of attributes so as to determine a target value of the indication parameter, in response to receiving an indication of using the use voucher.

14. The non-transitory computer-readable storage medium of claim 13, wherein the computer instructions are further configured to cause the computer to:
determine the content feature of the target digital content;
determine, from a knowledge graph associated with the target digital content, a reference digital content associated with the target digital content, based on the content feature of the target digital content;
determine a second reference value for a worth of the target digital content based on a first reference value for a worth of the reference digital content; and
determine a first value for the worth of the use voucher based on the second reference value for the worth of the target digital content.

15. The non-transitory computer-readable storage medium of claim 14, wherein the computer instructions are further configured to cause the computer to:
acquire a preset value for the worth of the target digital content; and
determine the first value for the worth of the use voucher based on the second reference value for the worth of the target digital content and the preset value for the worth of the target digital content.

16. The non-transitory computer-readable storage medium of claim 15, wherein the computer instructions are further configured to cause the computer to:
determine a set of users allowed to use the use voucher from users associated with the target digital content, based on the preset value for the worth of the target digital content and the user feature.

17. The non-transitory computer-readable storage medium of claim 13, wherein the computer instructions are further configured to cause the computer to:
adjust the attribute values of the set of attributes so as to acquire a set of adjusted attribute values, in response to receiving the indication of using the use voucher;
determine an adjusted value of the indication parameter based on the set of adjusted attribute values; and
compare the initial value of the indication parameter and the adjusted value of the indication parameter so as to determine the target value of the indication parameter.

18. The non-transitory computer-readable storage medium of claim 13, wherein the indication parameter is Cost Per Mille.
